(19) United States
(12) Patent Application Publication
(10) Pub. No.: US 2023/0162739 A1
(43) Pub. Date: May 25, 2023

(54) ELECTRONIC APPARATUS, SYSTEM COMPRISING SOUND I/O DEVICE AND CONTROLLING METHOD THEREOF

(71) Applicant: SAMSUNG ELECTRONICS CO., LTD., Suwon-si (KR)

(72) Inventors: Jubum HAN, Suwon-si (KR); Jaewon LEE, Suwon-si (KR); Jaeyoung ROH, Suwon-si (KR)

(73) Assignee: SAMSUNG ELECTRONICS CO., LTD., Suwon-si (KR)

(21) Appl. No.: 17/425,169

(22) PCT Filed: Jun. 30, 2021
(86) PCT No.: PCT/KR2021/008268

§ 371 Date: Jul. 22, 2021

(30) Foreign Application Priority Data
Feb. 1, 2021 (KR) 10-2021-0014270

(51) Int. Cl. G10L 17/20; G10L 17/24; G10L 17/18; G10L 21/0224; G10L 17/06; G06F 3/16

(52) U.S. Cl. CPC G10L 17/20; G10L 17/24; G10L 17/18; G10L 21/0224; G10L 17/06; G06F 3/162; G10L 2021/02166

(57) ABSTRACT

An electronic apparatus is provided. The electronic apparatus may include a communication interface; and a processor configured to: control the communication interface to output an audio content signal to a sound input/output device including a speaker and a microphone; based on receiving a sound signal collected via the microphone from the sound input/output device via the communication interface, identify whether the sound signal includes a scene noise signal corresponding to a regular noise generated in a location in which the sound input/output device is located or an event noise signal corresponding to an irregular noise generated in the location in which the sound input/output device is located; based on identifying that the sound signal includes the scene noise signal, perform noise cancelling for the sound signal; and based on identifying that the sound signal includes the event noise signal, control the output of the audio content signal

### TECHNICAL FIELD

The disclosure relates to an electronic apparatus that provides a service to a user based on a sound signal, a system including a sound input/output device, and a control method thereof.

### CROSS-REFERENCE TO RELATED APPLICATION(S)

This application is based on and claims priority to Korean Patent Application No. 10-2021-0014270, filed on Feb. 1, 2021, in the Korean Intellectual Property Office, the disclosure of which is incorporated by reference herein in its entirety.

### BACKGROUND ART

Technologies relating to a method of providing a voice recognition assistant service through a mobile electronic apparatus are being actively developed. An electronic apparatus that provides a voice recognition assistant service can identify a user's voice and other sounds by performing an artificial intelligence (AI)-based sound recognition operation.

However, in the case of performing a sound recognition operation entirely by an electronic apparatus, the electronic apparatus must be always on, and thus there is a problem due to the burden in power consumption. Accordingly, there has been a continuous demand for a method of identifying various types of sounds including a user's voice correctly, at the same time as alleviating the burden in power consumption of an electronic apparatus.

### DISCLOSURE

### Technical Problem

The disclosure may address the aforementioned need, and the disclosure provides an electronic apparatus that identifies various types of sounds included in an input sound through several stages, and performs different operations based on the identified types of sounds, and a control method thereof.

### Technical Solution

According to an aspect of the disclosure, an electronic apparatus may include a communication interface; and a processor configured to: control the communication interface to output an audio content signal to a sound input/output device including a speaker and a microphone; based on receiving a sound signal collected via the microphone from the sound input/output device via the communication interface, identify whether the sound signal includes a scene noise signal corresponding to a regular noise generated in a location in which the sound input/output device is located or an event noise signal corresponding to an irregular noise generated in the location in which the sound input/output device is located; based on identifying that the sound signal includes the scene noise signal, perform noise cancelling for the sound signal; and based on identifying that the sound signal includes the event noise signal, control the output of the audio content signal.

The processor may, based on the sound signal received from the sound input/output device being a signal not including a user voice input, identify whether the sound signal includes the scene noise signal or the event noise signal.

The processor may, based on the sound signal received from the sound input/output device being a signal including a user voice input, identify whether the sound signal includes a wake-up word; and based on the sound signal including the wake-up word, perform a voice recognition assistant function.

The processor may, based on the sound signal including the event noise signal, perform an operation related to at least one of stopping of the output of the audio content signal, adjusting of an output volume of the audio content signal, or providing of a feedback corresponding to the event noise signal.

The processor may input the sound signal into a first neural network model; and identify whether the sound signal includes the scene noise signal or the event noise signal based on an output of the first neural network, wherein the first neural network model is trained to, based on the sound signal being input, output information indicating whether the input sound signal is the scene noise signal or the event noise signal.

The processor may, based on identifying that a first type of a first scene noise signal received from the sound input/output device during a first time frame is different from a second type of a second scene noise signal received from the sound input/output device during a second time frame which is before the first time frame, transmit, to the sound input/output device via the communication interface, a control signal that causes the sound input/output device to collect a noise signal during a third time frame which is after the first time frame.

The processor may, based on a first type of a first scene noise signal received from the sound input/output device during a fourth time frame not being identified, transmit, to the sound input/output device via the communication interface, a control signal that causes the sound input/output device to collect a noise signal during a fifth time frame which is after the fourth time frame.

The processor may include an application processor; and a main processor. The main processor may, based on receiving the sound signal from the sound input/output device, control the application processor to be powered on. The application processor may identify whether the sound signal includes the scene noise signal or the event noise signal.

According to an aspect of the disclosure, a system may include a sound input/output device and configured to: output, via a speaker, an audio content signal received from an electronic apparatus, identify whether a sound signal collected via a microphone includes a user voice input, and transmit the sound signal and an identification result to the electronic apparatus. The system may include the electronic apparatus configured to: receive the sound signal collected via the microphone and the identification result from the sound input/output device, based on identifying that the sound signal does not include the user voice input based on the identification result, identify whether the sound signal includes a scene noise signal corresponding to a regular noise generated in a location in which the sound input/output device is located or an event noise signal corresponding to an irregular noise generated in the location in which the sound input/output device is located, based on the sound signal including the scene noise signal, perform noise cancelling for the sound signal, and based on the sound signal including the event noise signal, control an output of the audio content signal.

The sound input/output device may include a plurality of microphones that are provided in locations distanced from one another. The sound input/output device may identify whether the sound signal collected via the microphone includes the user voice input based on strength differences of sound signals received via the plurality of microphones.

The sound input/output device may input information related to whether the sound signal is a signal related to the user voice input and the sound signals collected via the plurality of microphones into a second neural network model; and identify whether the sound signal includes the user voice input based on an output of the second neural network model.

According to an aspect of an example embodiment, a control method of an electronic apparatus may include outputting an audio content signal to a sound input/output device worn by a user including a speaker and a microphone; based on receiving a sound signal collected via the microphone from the sound input/output device, identifying whether the sound signal includes a scene noise signal corresponding to a regular noise generated in a location in which the sound input/output device is located or an event noise signal corresponding to an irregular noise generated in the location in which the sound input/output device is located; based on identifying that the sound signal includes the scene noise signal, performing noise cancelling for the sound signal; and based on identifying that the sound signal includes the event noise signal, controlling the output of the audio content signal.

The identifying whether the sound signal includes the scene noise signal or the event noise signal may include, based on the sound signal received from the sound input/output device being a signal not including a user voice input, identifying whether the sound signal includes the scene noise signal or the event noise signal.

The method may include, based on the sound signal received from the sound input/output device being a signal including a user voice input, identifying whether the sound signal includes a wake-up word; and based on the sound signal including the wake-up word, performing a voice recognition assistant function.

The method may include, based on the sound signal including the event noise signal, performing an operation related to at least one of stopping of the output of the audio content signal, adjusting of an output volume of the audio content signal, or providing of a feedback corresponding to the event noise signal.

### Effect of Invention

According to the various embodiments of the disclosure, an electronic apparatus can identify various types of sounds included in an input sound correctly while consuming low power, and thus the satisfaction of a user who is provided with a voice recognition assistant service can be enhanced.

### DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for illustrating an appearance of a user located in a space wherein various types of sounds exist using an electronic apparatus;

FIG. 2 is a block diagram for illustrating a configuration of an electronic apparatus according to an embodiment of the disclosure;

FIG. 3 is a block diagram for illustrating functional configurations of an electronic apparatus and a sound input/output device according to an embodiment of the disclosure;

FIG. 4 is a block diagram for illustrating in detail functional configurations of an electronic apparatus and a sound input/output device according to an embodiment of the disclosure;

FIG. 5A is a diagram for illustrating different types of scene noise signals corresponding to characteristics of a space;

FIG. 5B is a diagram for illustrating different types of scene noise signals corresponding to characteristics of a space;

FIG. 6A is a diagram for illustrating event noise signals that are generated irregularly in a specific space;

FIG. 6B is a diagram for illustrating event noise signals that are generated irregularly in a specific space;

FIG. 7 is a diagram for illustrating a wake-up word identification operation of an electronic apparatus according to an embodiment of the disclosure;

FIG. 8 is a diagram for illustrating an operation of an electronic apparatus according to an embodiment of the disclosure of providing a user interface (UI) corresponding to an event noise to a user;

FIG. 9A is a diagram for illustrating various neural network models according to an embodiment of the disclosure;

FIG. 9B is a diagram for illustrating various neural network models according to an embodiment of the disclosure;

FIG. 9C is a diagram for illustrating various neural network models according to an embodiment of the disclosure;

FIG. 10 is a diagram for illustrating an operation of an electronic apparatus according to an embodiment of the disclosure of identifying characteristics of a space that change according to movements of a user;

FIG. 11 is a block diagram for illustrating in detail a configuration of an electronic apparatus according to an embodiment of the disclosure; and

FIG. 12 is a flow chart for illustrating a control method according to an embodiment of the disclosure.

### DETAILED DESCRIPTION OF EXEMPLARY EMBODIMENTS

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies. Also, in particular cases, there are terms that were designated by the applicant on his own, and in such cases, the meaning of the terms will be described in detail in the relevant descriptions in the disclosure. Thus, the terms used in the disclosure should be defined based on the meaning of the terms and the overall content of the disclosure, but not just based on the names of the terms.

Also, in the disclosure, expressions such as “have,” “may have,” “include,” and “may include” should be construed as denoting that there are such characteristics (e.g., elements such as numerical values, functions, operations, and components), and the terms are not intended to exclude the existence of additional characteristics.

In addition, the expression “at least one of A and/or B” should be interpreted to mean any one of “A,” “B,” or “A and B.”

Further, the expressions “first,” “second,” and the like, used in the disclosure may be used to describe various elements regardless of any order and/or degree of importance. Also, such expressions are used only to distinguish one element from another element, and are not intended to limit the elements.

The description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

Also, singular expressions include plural expressions, unless defined obviously differently in the context. Further, in the disclosure, terms such as “include” and “comprise” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and it may be implemented as hardware or software, or as a combination of hardware and software. Further, a plurality of “modules” or “parts” may be integrated into at least one module and implemented as at least one processor (not shown), except “modules” or “parts” that need to be implemented as specific hardware.

Also, in the disclosure, the term “user” may refer to a person who uses an electronic apparatus. Hereinafter, an embodiment of the disclosure will be described in more detail with reference to the accompanying drawings.

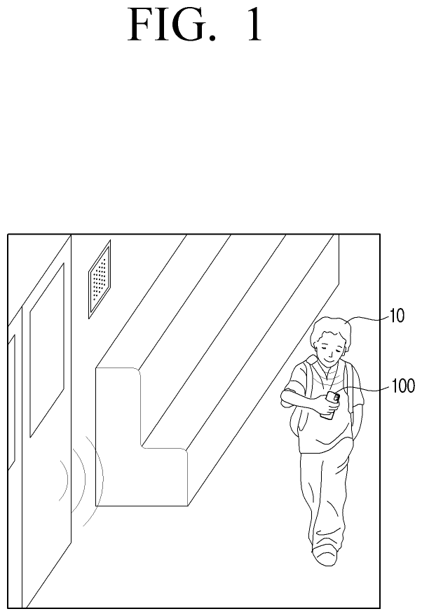

FIG. 1 is a diagram for illustrating an appearance of a user located in a space wherein various types of sounds exist using an electronic apparatus.

Referring to FIG. 1, a user 10 who is using the electronic apparatus 100 is riding on the subway. The electronic apparatus 100 may provide an AI voice recognition assistant function, and the voice recognition assistant function according to an embodiment of the disclosure may mean the entire services of providing response information to a user when a user's voice input is input into the electronic apparatus 100 based on the user uttering a voice input.

In the space wherein the user 10 is located, various types of sounds may be generated. For example, for the user 10 who is located in an inner space of the subway, sounds corresponding to regular noises that are generated according to the operation of the subway, and noises in the case of emergency related to the operation of the subway (e.g., a guide voice, etc.) may be generated.

In such an environment, in case the user 10 inputs a voice input to be provided with a voice recognition assistant service from the electronic apparatus 100, there may be a case where the electronic apparatus 100 cannot identify the voice of the user 10 correctly due to various types of sounds that are generated in the surroundings.

Accordingly, various embodiments wherein various types of sounds included in a sound input into the electronic apparatus 100 are identified through several stages, and different operations are performed based on the identified types of sounds will be described in more detail.

In this specification, various types of noises that are generated in the surroundings of the user as well as the voice of the user 10 will be described by using the term ‘sound’ in general. Also, ‘a noise’ and a Korean expression having the same meaning will be interchangeably used in the specification.

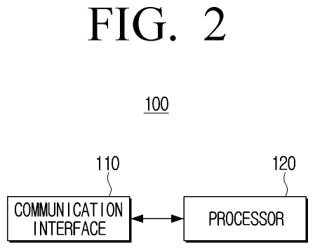

FIG. 2 is a block diagram for illustrating a configuration of an electronic apparatus according to an embodiment of the disclosure.

Referring to FIG. 2, the electronic apparatus 100 according to an embodiment of the disclosure may include a communication interface 110 and a processor 120.

The communication interface 110 may input and output various types of data. For example, the communication interface 110 may transmit and receive various types of data with an external apparatus (e.g., a source apparatus), an external storage medium (e.g., a universal serial bus (USB) memory), and an external server (e.g., a webhard) through communication methods such as wireless fidelity (Wi-Fi) based on access point (AP) (e.g., Wi-Fi, a wireless local area network (LAN), etc.), Bluetooth, Zigbee, wired LANs, wireless LANs, a wide area network (WAN), Ethernet, IEEE 1394, a high-definition multimedia interface (HDMI), USB, a mobile high-definition link (MHL), Audio Engineering Society/European Broadcasting Union (AES/EBU), optical, coaxial, etc.

The processor 120 controls the overall operations of the electronic apparatus 100. Specifically, the processor 120 may be connected with the respective components of the electronic apparatus 100 and control the overall operations of the electronic apparatus 100. For example, the processor 120 may be connected with the communication interface 110 and control the operations of the electronic apparatus 100.

According to an embodiment of the disclosure, the processor 120 may be referred to by various names such as a digital signal processor (DSP), a microprocessor, a central processing unit (CPU), a micro controller unit (MCU), a micro processing unit (MPU), a neural processing unit (NPU), a controller, an application processor (AP), etc., but in this specification, it will be described as the processor 120.

Also, the processor 120 may be implemented as a system on chip (SoC), or a large scale integration (LSI), and it may also be implemented in the form of a field programmable gate array (FPGA). In addition, the processor 120 may include a volatile memory such as a static random access memory (SRAM), etc.

A function related to AI according to the disclosure may be executed through the processor 120 and a memory. The processor 120 may include one or a plurality of processors. The one or plurality of processors may be generic-purpose processors such as a CPU, an AP, a DSP, etc., graphic-dedicated processors such as a graphics processing unit (GPU), a vision processing unit (VPU), etc., or AI-dedicated processors such as an NPU. The one or plurality of processors 120 perform control to process input data according to predefined operation rules or a neural network model stored in the memory. Alternatively, in case the one or plurality of processors 120 are AI-dedicated processors, the AI-dedicated processors may be designed in a hardware structure specified for processing of a specific neural network model.

The predefined operation rules or the artificial intelligence model are characterized in that they are made through learning. The feature of being made through learning means that a basic neural network model is trained by using a plurality of learning data by a learning algorithm, and predefined operation rules or an AI model set to perform a desired characteristic (or, purpose) are thereby made. Such learning may be performed in a device itself wherein AI is performed according to the disclosure, or performed through a separate server and/or system. As examples of learning algorithms, there are supervised learning, unsupervised learning, semi-supervised learning, or reinforcement learning, but learning algorithms are not limited to the aforementioned examples.

The processor 120 according to an embodiment of the disclosure may control the communication interface 110 to output an audio content signal to a sound input/output device including a speaker and a microphone.

The sound input/output device may be a wearable device that a user wears. Also, the sound input/output device according to an embodiment of the disclosure may be implemented as an earphone, and in this case, the sound input/output device may include a separate communication interface, and electronically communicate with the electronic apparatus 100.

The sound input/output device according to an embodiment of the disclosure may output an audio content signal received from the electronic apparatus 100 through the speaker. Also, the sound input/output device may identify whether a sound signal collected through the microphone includes a user voice, and transmit the collected sound signal and the identification result to the electronic apparatus 100.

In addition, if a sound signal collected via the microphone is received from the sound input/output device via the communication interface 110, the processor 120 may identify whether the sound signal includes a scene noise signal or an event noise signal.

A scene noise signal may be a signal corresponding to a noise that is regularly generated in a space wherein a user is located. Specifically, a scene noise signal may be a signal corresponding to a regular noise that is generated according to the operation of the subway, a regular noise that is generated by birds that live in a park, or a noise such as a wind noise that is generated by a vehicle running on a roadside, etc. A regular noise may refer to a noise that occurs at uniform, consistent, rhythmic, etc., intervals at a particular location. Further, a regular noise may refer to a noise that is expected at the location, and that does not warrant much attention from the user.

An event noise signal may be a signal corresponding to a noise that is irregularly (unexpectedly) generated in a location wherein a user is located. Specifically, an event noise signal may be a signal corresponding to a noise in the case of emergency related to the operation of the subway (e.g., a guide voice, etc.), a barking sound of a dog of a pedestrian taking a walk in a park, or a noise such as a honk that is generated by a vehicle running on a roadside, etc. An irregular noise may refer to a noise that does not occur at uniform, consistent, rhythmic, etc., intervals at a particular location. Further, an irregular noise may refer to a noise that is unexpected at the location, and that might warrant attention from the user.

If the sound signal received from the sound input/output device includes a scene noise signal, the processor 120 may perform noise cancelling for the sound signal.

Noise canceling may mean an operation of the electronic apparatus 100 of generating a signal of a wavelength that is opposite to the wavelength of a signal identified as a noise to be removed among signals included in a sound signal, and removing the noise by offset interference between the signals.

If the sound signal received from the sound input/output device includes an event noise signal, the processor 120 according to an embodiment of the disclosure may control the output of the audio content signal output from the sound input/output device.

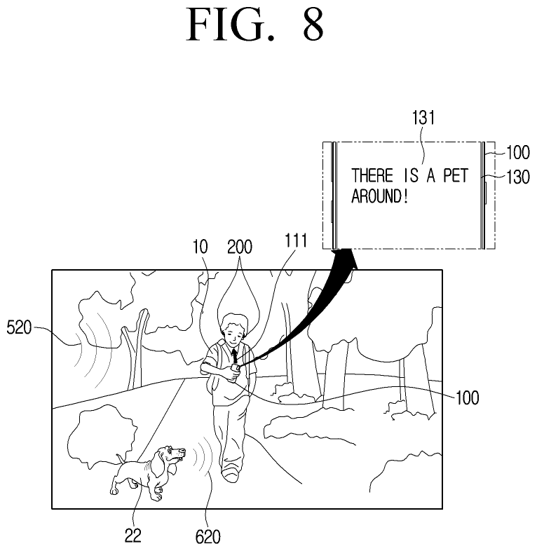

Specifically, if the sound signal received from the sound input/output device includes an event noise signal, the processor 120 according to an embodiment of the disclosure may perform an operation related to at least one of stopping of the output of the audio content signal, adjusting of the output volume, or providing of a feedback corresponding to the event noise signal. Detailed explanation in this regard will be made with reference to FIG. 8.

If the sound signal received from the sound input/output device is a signal not including a user voice, the processor 120 may identify whether the sound signal includes a noise signal or an event signal.

If the sound signal received from the sound input/output device is a signal including a user voice input, the processor 120 may identify whether the sound signal includes a wake-up word.

A wake-up word means a word or a sentence that can activate the voice recognition assistant function provided by the electronic apparatus 100, among words or sentences included in a user voice input. A wake-up word can be set in advance in the manufacturing step of the electronic apparatus 100, and editing such as addition, deletion, etc., is possible according to a user's setting. As another example, a wake-up word may be changed or added through a firmware update, etc.

If it is identified that the sound signal includes a wake-up word, the processor 120 may perform the voice recognition assistant function.

The processor 120 according to an embodiment of the disclosure may input a sound signal into a first neural network model, and identify whether the sound signal includes a scene noise signal or an event noise signal.

Also, the first neural network model may be a model trained to, if a sound signal is input, output information indicating whether the input sound signal is a scene noise signal or an event noise signal.

If it is identified that the type of a scene noise signal received from the sound input/output device during a first threshold time is different from the type of a scene noise signal received during a second threshold time which is before the first threshold time, the processor 120 according to an embodiment of the disclosure may transmit a control signal making the sound input/output device collect a noise signal during a third threshold time which is after the first threshold time to the sound input/output device through the communication interface 110.

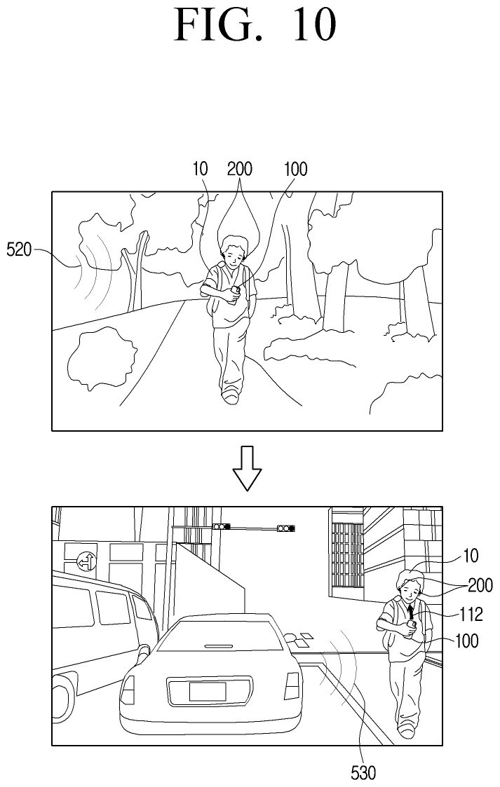

Also, in case the type of a scene noise signal received from the sound input/output device during a fourth threshold time is not identified, the processor 120 according to an embodiment of the disclosure may transmit a control signal making the sound input/output device collect a noise signal during a fifth threshold time which is after the fourth threshold time to the sound input/output device through the communication interface 110. The aforementioned operation of transmitting a control signal will be described in detail with reference to FIG. 10.

The processor 120 according to an embodiment of the disclosure may include an AP and a main processor.

The AP may be a processor that is implemented in a form wherein a plurality of units performing various functions including a CPU performing main operations are integrated in one chip. In the AP according to an embodiment of the disclosure, a CPU, a memory, and a GPU, etc., may be included. For this reason, the application processor is also referred to as a system on chip (SoC).

The main processor may be a processor that controls the overall operations of the electronic apparatus 100 including the AP, and that manages to provide power for the components of the electronic apparatus 100 correctly and effectively. The main processor according to an embodiment of the disclosure may provide power supplied by a power supply part included in the electronic apparatus 100 to the AP, and the main processor is also referred to as a power management integrated circuit (PMIC).

The main processor according to an embodiment of the disclosure may control the AP to be powered on if a sound signal is received from the sound input/output device. The feature that the AP is powered on may mean that the AP was not consuming power previously, and then perform an operation by consuming power after it is powered on, and may also mean that the AP was consuming a first power (a standby power) previously, and then perform an operation by consuming a second power (an operating power) after it is powered on.

The AP according to an embodiment of the disclosure may identify whether a sound signal includes a scene noise signal or an event noise signal.

As a result, in case in which a sound signal is not received from the sound input/output device, the AP does not consume power or consumes only a small amount of power, and thus the standby power consumed by the electronic apparatus 100 can be reduced on the whole.

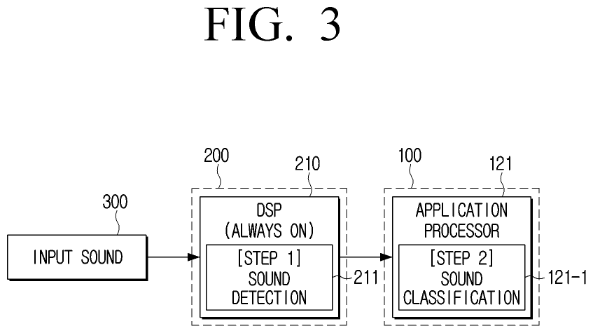

FIG. 3 is a block diagram for illustrating functional configurations of an electronic apparatus and a sound input/output device according to an embodiment of the disclosure.

Referring to FIG. 3, a method of processing an input sound 300 by an AP 121 which is one component of the electronic apparatus 100 and a DSP 210 which is one component of the sound input/output device 200 will be described in detail.

The DSP 210 included in the sound input/output device 200 may be a microprocessor implemented as an IC that processes signals by digital operations. The DSP 210 according to an embodiment of the disclosure may convert the input sound 300 which is analog data into a digital signal expressed as 0 and 1, and perform signal processing and an operation.

The sound input/output device 200 according to an embodiment of the disclosure may collect the input sound 300 via the microphone. The DSP 210 according to an embodiment of the disclosure may process sound data included in the collected input sound 300 by a specific method. The sound data may be data including ‘a sound signal’ that was mentioned in describing the function of the processor 120 with reference to FIG. 2.

The specific method may mean analysis of frequency components for a sound signal included in the input sound 300, collection and storage of a sound signal during a threshold time, or identification of sensor data of the sound input/output device and sound data corresponding thereto, etc., but these are merely one example, and the specific method is not necessarily limited thereto. In FIG. 3, an operation of the DSP of processing the input sound 300 by a specific method will be expressed as sound detection 211.

Also, the DSP 210 according to an embodiment of the disclosure may transmit sound data processed through the sound detection 211 to the electronic apparatus 100.

The electronic apparatus 100 according to an embodiment of the disclosure may receive the sound data processed through the sound detection 211 from the sound input/output device 200 through the communication interface 110. When the sound data is identified, the AP 121 may perform a sound classification 121-1 operation. The sound classification 121-1 operation may include the following operations.

First, the AP 121 may identify whether a user voice input is included in the sound data. In a case in which the sound data includes a user voice input, the AP 121 may identify whether the user voice input includes a wake-up word, and in case the user voice input includes a wake-up word, the AP 121 may perform the voice recognition assistant function.

In a case in which the sound data does not include a user voice input, the AP 121 according to an embodiment of the disclosure may identify whether a scene noise signal or an event noise signal is included in the sound data. In a case in which a scene noise signal or an event noise signal is included in the sound data, the AP 121 may perform different operations based on the identified noise type.

In a case in which a scene noise signal is included in the sound data, the AP 121 according to an embodiment of the disclosure may perform noise cancelling for the sound data, and in case an event noise signal is included in the sound data, the AP 121 may control the output of the audio content signal.

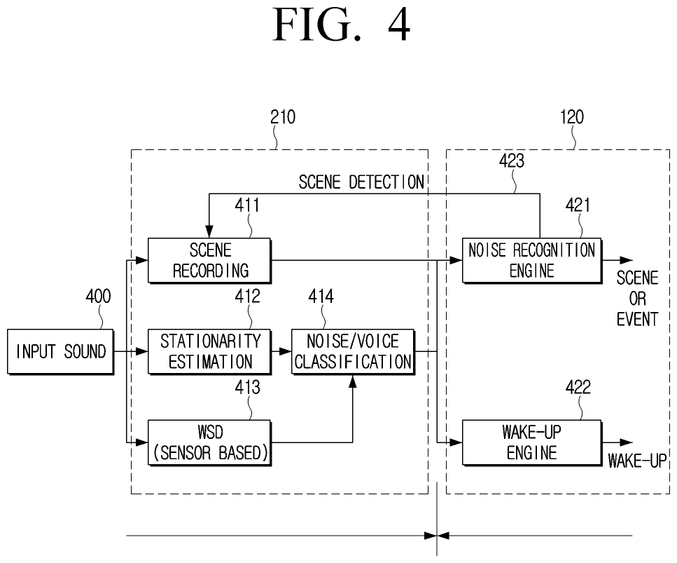

FIG. 4 is a block diagram for illustrating in detail functional configurations of an electronic apparatus and a sound input/output device according to an embodiment of the disclosure.

Referring to FIG. 4, the DSP 210 of the sound input/output device 200 may process sound data included in an input sound 400 input into the sound input/output device 200 by various methods.

The DSP 210 according to an embodiment of the disclosure may perform scene recording 411. The scene recording 411 may mean an operation of collecting an input sound signal during a threshold time, converting the collected sound signal into a digital signal, and storing the signal. Through the scene recording 411, the DSP 210 may collect various types of sound signals that are generated in a space wherein a user wearing the sound input/output device 200 is located.

Also, the DSP 210 may perform stationarity estimation 412. The stationarity estimation 412 may mean an operation of converting the input sound 400 in the form of data to be input into a neural network model before classifying a user voice and the other sound signals (noises) excluding the user voice among the sound signals included in the input sound 400.

Specifically, the DSP 210 according to an embodiment of the disclosure may perform frequency analysis for the sound signals included in the input sound 400 through the stationarity estimation 412, and convert the sound data including the sound signals for which frequency analysis was performed into data in the form of a matrix (N*N).

In addition, the DSP 210 may perform wearer speech detection 413. The wearer speech detection 413 may mean an operation of detecting a user's utterance based on sensing data acquired through a sensor included in the sound input/output device 200.

Specifically, the sound input/output device 200 according to an embodiment of the disclosure may include a plurality of microphones that are arranged in locations distanced from one another, and in this case, the input sound 400 may include a plurality of data corresponding to the sounds collected from the plurality of respective microphones.

The DSP 210 according to an embodiment of the disclosure may acquire information on the strength differences of the sound signals received through the plurality of respective microphones through the wearer speech detection 413. As the distance difference of a user's voice from a generation source of a signal (the user's vocal organ) to the plurality of microphones is extremely small, unlike the ambient noises, the strength differences of the sound signals received through the plurality of respective microphones may be smaller than a threshold difference.

However, this is merely an example, and the DSP 210 may acquire information different from the above through the wearer speech detection 413. Specifically, the DSP 210 according to another embodiment of the disclosure may acquire information on a time difference at which a signal having the same frequency characteristic was input for the sound signals received through the plurality of respective microphones.

Also, the sound input/output device 200 may perform noise/voice classification 414. The noise/voice classification 414 may mean an operation of inputting data acquired as a result of the stationarity estimation 412 and data acquired through the wearer speech detection 413 into a neural network model and identifying whether the input sound 400 includes a user voice.

The neural network model may be a model trained to receive input of a plurality of data related to the input sound 400 and output information on whether the input sound 400 includes a user voice input.

In FIG. 3, the component identifying whether the input sound 300 includes a user voice input was the AP 121, but in FIG. 4, the functions of the electronic apparatus 100 and the sound input/output device 200 were described on the premise that the DSP 210 can also perform such a function.

Also, the DSP 210 according to an embodiment of the disclosure may transmit the sound data processed through the noise/voice classification 414 and the sound signals collected through the scene recording 411 to the electronic apparatus 100.

If sound data received from the sound input/output device 200 and information on whether the input sound 400 includes a user voice input are received, the processor 120 according to an embodiment of the disclosure may activate a nose recognition engine 421 or a wake-up engine 422.

The noise recognition engine 421 according to an embodiment of the disclosure may input the sound data included in the input sound 400 collected during a threshold time through the scene recording 411 of the DSP 210 and the sound data identified as a noise by the noise/voice classification 414 into the neural network model, and identify whether the input sound 400 includes a scene noise signal or an event noise signal.

The wake-up engine 422 according to an embodiment of the disclosure may input the sound data identified as a voice by the noise/voice classification 414 into the neural network model, and identify whether the input sound 400 includes a wake-up word. Also, if a wake-up word is identified, the wake-up engine 422 may perform the voice recognition assistant function provided by the electronic apparatus 100.

If it is identified that the type of a scene noise corresponding to the characteristic of a space wherein a user is located has changed according to the passage of time, the noise recognition engine 421 according to an embodiment of the disclosure may transmit 423 a control signal making the sound input/output device 200 collect a noise signal (scene detection) during a threshold time to the sound input/output device 200 through the communication interface 110.

Also, the noise recognition engine 421 according to an embodiment of the disclosure may transmit such a control signal to the sound input/output device 200 even when the type of a scene noise corresponding to the characteristic of a space wherein a user is located is not identified.

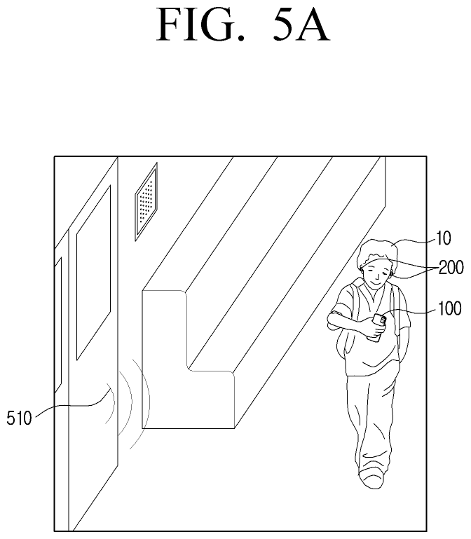

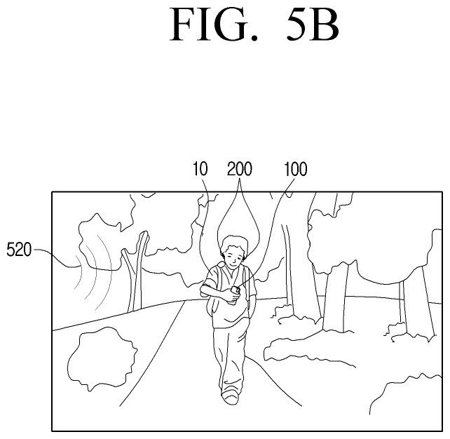

FIG. 5A and FIG. 5B are diagrams for illustrating different types of scene noise signals corresponding to characteristics of a space.

Referring to FIG. 5A, the user 10 of the electronic apparatus 100 is located in an inner space of the subway that is being operated while wearing the sound input/output device 200. The sound input/output device 200 may be a cordless earphone.

In an operating process of the subway, a regular noise 510 that is generated by friction between the driving part of the subway and the railway, etc., may be introduced into the inner space of the subway.

Referring to FIG. 5B, the user 10 of the electronic apparatus 100 is located on a walkway of a park while wearing the sound input/output device 200.

In the park, a regular noise 520 that is generated by birds that live in an adjacent area to vegetation, etc., may be transmitted to the user.

As can be seen above, the types of regular noises (hereinafter, referred to as “scene noises”) collected by the sound input/output device 200 may vary according to the characteristic of a space wherein the user 10 of the electronic apparatus 100 is located.

The electronic apparatus 100 according to an embodiment of the disclosure may collect a scene noise corresponding to the characteristic of the space and perform noise cancelling based on the noise, so that the user 10 provided with an audio content from the sound input/output device 200 does not feel uncomfortable by a scene noise generated around the user 10.

Specifically, in FIG. 5A, the electronic apparatus 100 may remove the noise 510 by offset interference between signals by generating a signal of a wavelength that is opposite to the wavelength of the scene noise 510 generated on the subway, and in FIG. 5B, the electronic apparatus 100 may remove the noise 520 by offset interference between signals by generating a signal of a wavelength that is opposite to the wavelength of the scene noise 520 generated in the park.

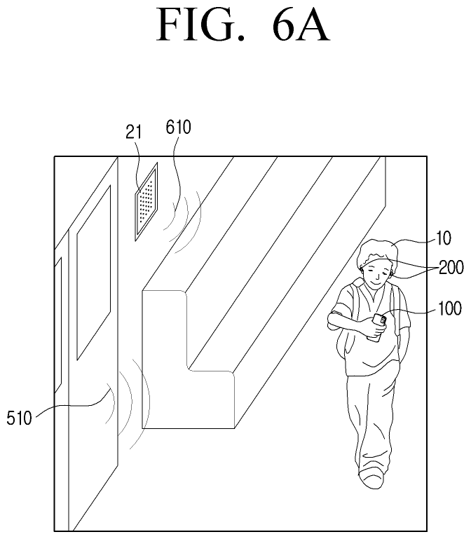

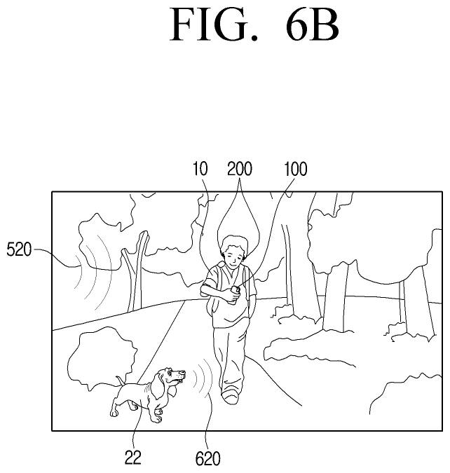

FIG. 6A and FIG. 6B are diagrams for illustrating event noise signals that are generated irregularly in a specific space.

Referring to FIG. 6A, to a user 10 who is located on the subway, a guide voice 610 that is generated from a speaker 21 located inside the subway may be transmitted. The guide voice 610 according to an embodiment of the disclosure may be a voice regarding information on a station at which the subway will stop, and as intervals between stations and driving speeds of the subway in respective sections are not regular, the guide voice 610 may be a noise in case of emergency (hereinafter, an “event noise”) that is not generated regularly.

Referring to FIG. 6B, to a user 10 who is located in a park, a sound 620 of a pet dog 22 located on a walkway may be transmitted. The barking sound 620 according to an embodiment of the disclosure may be an event noise generated based on the pet dog 22 and the specific environment around the pet dog 22.

An event noise may be a noise that includes useful information for a user or a noise that makes a user recognize an unexpected situation. Thus, the electronic apparatus 100 according to an embodiment of the disclosure may not perform noise cancelling for an event noise.

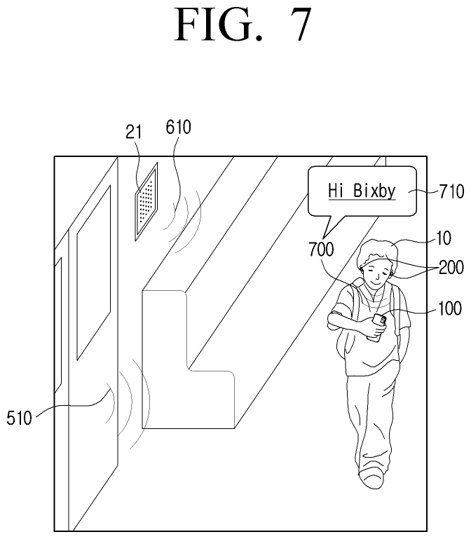

FIG. 7 is a diagram for illustrating a wake-up word identification operation of an electronic apparatus according to an embodiment of the disclosure.

The electronic apparatus 100 according to an embodiment of the disclosure may identify whether a sound signal received from the sound input/output device 200 is a signal including a user voice input 700.

Specifically, the electronic apparatus 100 according to an embodiment of the disclosure may identify a scene noise 510 transmitted to the user 10 located inside the subway, an event noise 610, and a wake-up word 710 included in an input sound including the user voice input 700.

Also, if it is identified that a sound signal received from the sound input/output device 200 is a signal including a user voice input 700, the electronic apparatus 100 may identify whether a wake-up word 710 is included in the sound signal.

A wake-up word is a word or a sentence for executing a voice recognition assistant function provided by the electronic apparatus 100, and a wake-up word according to an embodiment of the disclosure may include “Hi Bixby.” In this case, the electronic apparatus 100 may input an input sound into a neural network model and identify the wake-up word 710 of “Hi Bixby” included in the user voice input 700, and perform the voice recognition assistant function based on this.

FIG. 8 is a diagram for illustrating an operation of an electronic apparatus according to an embodiment of the disclosure of providing a UI corresponding to an event noise to a user.

If it is identified that an input sound collected from the sound input/output device 200 includes an event noise corresponding to the barking sound 620 of the pet dog 22, the electronic apparatus 100 according to an embodiment of the disclosure may transmit a control signal 111 stopping the output of an audio content signal provided through the sound input/output device 200.

According to another embodiment of the disclosure, the control signal 111 may be a signal related to at least one of an operation of adjusting the volume of the sound input/output device 200 or an operation of providing a feedback corresponding to the event noise 620 through the sound input/output device 200.

In this way, the user 10 may recognize the presence of the pet dog 22 located in the vicinity and the unexpected situation in the vicinity that induced the pet dog 22 to bark, and pay attention.

Further, the electronic apparatus 100 according to an embodiment of the disclosure may provide a UI 131 corresponding to the event noise 620 through the display 130 provided on the electronic apparatus 100. In this case, the electronic apparatus 100 may store information on various types of event noises in the memory for identifying that the event noise 620 corresponds to a barking sound of a pet dog.

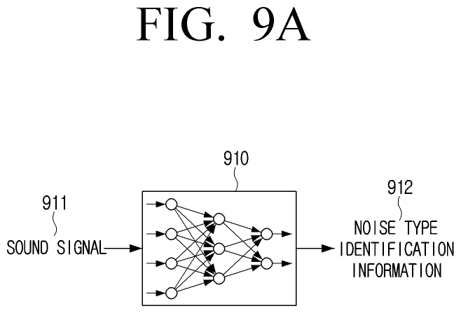

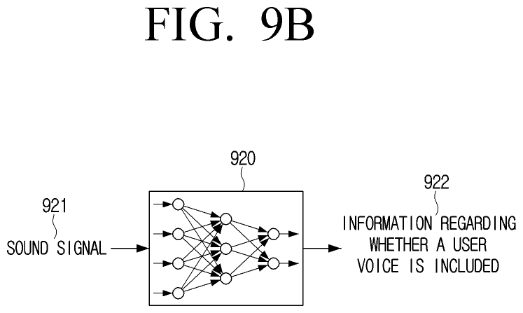

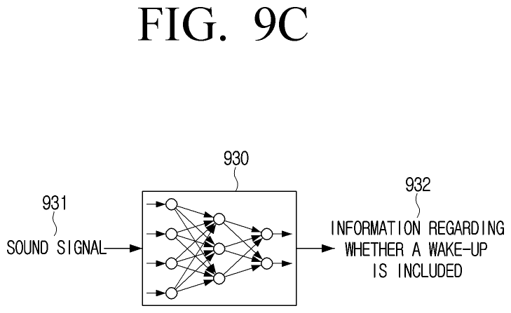

FIG. 9A to FIG. 9C are diagrams for illustrating various neural network models according to an embodiment of the disclosure.

Each of the plurality of neural network models illustrated in FIG. 9A to FIG. 9C may include a plurality of neural network layers. Each of the plurality of neural network layers has a plurality of weight values, and performs a neural network operation through an operation between the operation result of the previous layer and the plurality of weight values. The plurality of weight values that the plurality of neural network layers have may be optimized by a learning result of a neural network model. For example, the plurality of weight values may be updated such that a loss value or a cost value acquired from a neural network model during a learning process is reduced or minimized. An artificial neural network may include a deep neural network (DNN), and there are, for example, a convolutional neural network (CNN), a recurrent neural network (RNN), a restricted Boltzmann Machine (RBM), a deep belief network (DBN), a bidirectional recurrent deep neural network (BRDNN), or deep Q-networks, etc., but the disclosure is not limited to the aforementioned examples.

Referring to FIG. 9A, the first neural network model 910 may be a model trained to receive input of a sound signal 911 and output identification information 912 of the noise type of the noise signal included in the input sound signal. Specifically, the first neural network model 910 may be a model trained to, if a sound signal 911 is input, output information 912 indicating whether the input sound signal is a scene noise signal or an event noise signal.

Referring to FIG. 9B, the second neural network model 920 may be a model trained to receive input of a plurality of data 921 related to sound signals and output information 922 regarding whether the plurality of input data include user voice inputs. Specifically, the plurality of data 921 related to sound signals may include data converted into the form of a matrix (N*N) after performing frequency analysis for the sound signals and information on the difference in strength of the sound signals received through the plurality of respective microphones included in the sound input/output device 200.

Referring to FIG. 9C, the third neural network model 930 may be a model trained to receive input of a sound signal 931 and output information 932 regarding whether the sound signal includes a wake-up word.

FIG. 10 is a diagram for illustrating an operation of an electronic apparatus according to an embodiment of the disclosure of identifying characteristics of a space that change according to movements of a user.

Referring to FIG. 10, it can be identified that the user 10 has moved to the road side after taking a walk in the park. In this case, a scene noise 520 collected by the sound input/output device 200 in the park and a scene noise 530 collected on the road side may include noise signals having different frequency characteristics.

In this case, the electronic apparatus 100 needs to collect and store scene noises corresponding to a new space for performing satisfying noise cancelling in response to change of noise types according to change of characteristics of a space wherein the user 10 is located.

Accordingly, if it is identified that the type of the scene noise 530 collected by the sound input/output device 200 while the user 10 is walking on the road side (hereinafter, a first threshold time) after walking out of the park is different from the type of the scene noise 520 collected by the sound input/output device 200 while the user 10 took a walk in the park (hereinafter, a second threshold time) corresponding to the previous time thereof, the electronic apparatus 100 may transmit a control signal 112 making the noise signal 530 that is generated on the road side during a third threshold time after the first threshold time collected to the sound input/output device 200 through the communication interface 110.

The sound input/output device 200 that received the control signal 112 may collect the scene noise 530 generated on the road side during the third threshold time, and transmit this to the electronic apparatus 100. As a result, the electronic apparatus 100 becomes capable of performing more satisfying noise cancelling based on the new scene noise 530 corresponding to the characteristic of the changed space.

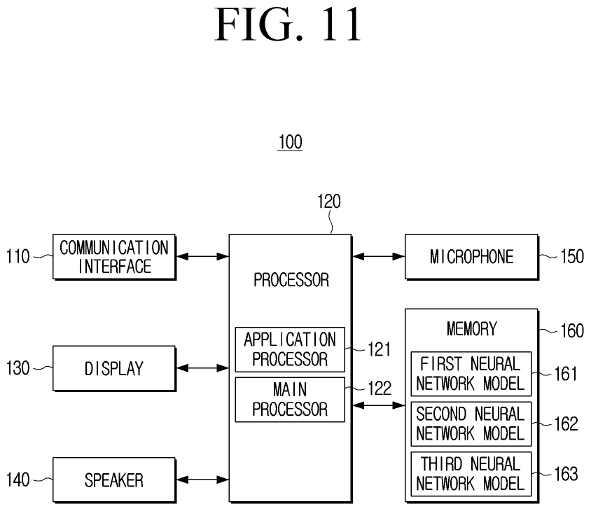

FIG. 11 is a block diagram for illustrating in detail a configuration of an electronic apparatus according to an embodiment of the disclosure.

According to FIG. 11, the electronic apparatus 100 includes a communication interface 110, a processor 120, a display 130, a speaker 140, a microphone 150, and a memory 160. Among the components illustrated in FIG. 11, regarding components that overlap with the components illustrated in FIG. 2, detailed explanation will be omitted.

The processor 120 according to an embodiment of the disclosure may include an AP 121 and a main processor 122.

The display 130 may be implemented as displays in various forms such as a liquid crystal display (LCD), an organic light emitting diodes (OLED) display, a quantum dot light-emitting diodes (QLED) display, a plasma display panel (PDP), etc. Inside the display 130, driving circuits that may be implemented in forms such as an a-si TFT, a low temperature poly silicon (LTPS) TFT, an organic TFT (OTFT), etc., and a backlight unit, etc. may also be included together. The display 130 may also be implemented as a flexible display, a three-dimensional (3D) display, etc.

The speaker 140 is a device that converts an electronic sound signal of the electronic apparatus 100 into a sound wave. The speaker 140 may include a permanent magnet, a coil, and a vibration plate, and it may output a sound by vibrating the vibration plate by an electromagnetic interaction that is generated between the permanent magnet and the coil.

In a case in which the processor 120 according to an embodiment of the disclosure executes a function of the electronic apparatus 100 based on voice response information corresponding to a user voice, the processor 120 may control the speaker 140 to output a voice corresponding to the response information.

The microphone 150 is a component that collects an input sound by receiving a user's voice and an ambient noise signal. Specifically, the microphone 150 is a component that generally refers to a device that receives input of a sound wave and generates a current of the same waveform as the sound wave. The processor 120 according to an embodiment of the disclosure may convert a sound signal included in an input sound into a digital signal based on the current of the waveform generated by the microphone 150.

In the previous descriptions of the drawings, descriptions were made based on the premise that a sound signal is collected by the sound input/output device 200 including a microphone. However, the electronic apparatus 100 may implement the various functions included in the disclosure without the sound input/output device 200, and in this case, the microphone 150 provided on the electronic apparatus 100 may collect a sound signal in place of the microphone of the sound input/output device 200.

The memory 160 may store data for the various embodiments of the disclosure. The memory 160 may be implemented in the form of a memory embedded in the electronic apparatus 100, or in the form of a memory that can be attached to or detached from the electronic apparatus 100 according to the use of stored data. For example, in the case of data for driving the electronic apparatus 100, the data may be stored in a memory embedded in the electronic apparatus 100, and in the case of data for an extended function of the electronic apparatus 100, the data may be stored in a memory that can be attached to or detached from the electronic apparatus 100. In the case of a memory embedded in the electronic apparatus 100, the memory may be implemented as at least one of a volatile memory (e.g., a dynamic RAM (DRAM), a SRAM, or a synchronous dynamic RAM (SDRAM), etc.) or a non-volatile memory (e.g., an one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash, etc.), a hard drive, or a solid state drive (SSD)). Also, in the case of a memory that can be attached to or detached from the electronic apparatus 100, the memory may be implemented in a form such as a memory card (e.g., compact flash (CF), secure digital (SD), micro secure digital (Micro-SD), mini secure digital (Mini-SD), extreme digital (xD), a multi-media card (MMC), etc.) and an external memory that can be connected to a USB port (e.g., a USB memory), etc.

Also, the memory 160 according to an embodiment of the disclosure may include a plurality of neural network models including the first neural network model 161, the second neural network model 162, and the third neural network model 163. The first to third neural network models 161-163 were described in detail in FIG. 9A to FIG. 9C.

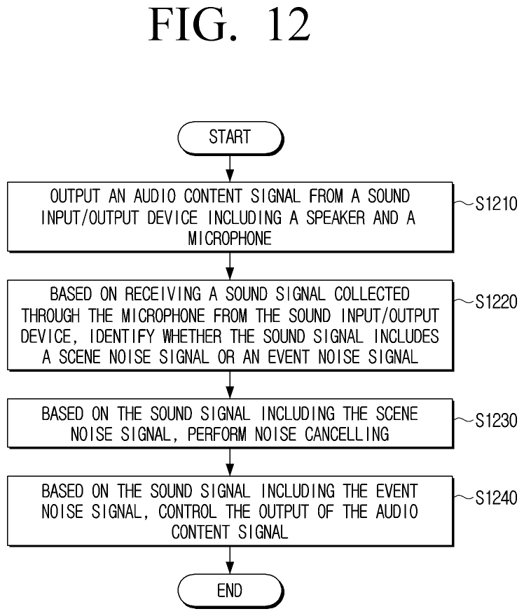

FIG. 12 is a flow chart for illustrating a control method according to an embodiment of the disclosure.

The controlling method of an electronic apparatus according to an embodiment of the disclosure may include the steps of outputting an audio content signal from a sound input/output device including a speaker and a microphone (operation S1210), based on receiving a sound signal collected via the microphone from the sound input/output device, identifying whether the sound signal includes a scene noise signal or an event noise signal (operation S1220), based on the sound signal including the scene noise signal, performing noise cancelling for the sound signal (operation S1230), and based on the sound signal including the event noise signal, controlling the output of the audio content signal (operation S1240).

In the step of identifying whether the sound signal includes a scene noise signal or an event noise signal (operation S1220), based on the sound signal received from the sound input/output device being a signal not including a user voice input, it may be identified whether the sound signal includes a scene noise signal or an event noise signal.

The control method may further include the steps of, based on the sound signal received from the sound input/output device being a signal including a user voice, identifying whether the sound signal includes a wake-up word, and based on the sound signal including a wake-up word, performing a voice recognition assistant function.

Also, the control method may further include the step of, based on the sound signal including the event noise signal, performing an operation related to at least one of stopping of the output of the audio content signal, adjusting of the output volume, or providing of a feedback corresponding to the event noise signal.

In the step of identifying whether the sound signal includes a scene noise signal or an event noise signal (operation S1220), the sound signal may be input into a first neural network model and it may be identified whether the sound signal includes a scene noise signal or an event noise signal, and the first neural network model may be a model trained to, based on a sound signal being input, output information indicating whether the input sound signal is a scene noise signal or an event noise signal.

Also, the control method may further include the step of, based on identifying that the type of a scene noise signal received from the sound input/output device during a first threshold time being different from the type of a scene noise signal received during a second threshold time which is before the first threshold time, transmitting a control signal making the sound input/output device collect a noise signal during a third threshold time which is after the first threshold time to the sound input/output device.

In addition, the control method may further include the step of, based on the type of a scene noise signal received from the sound input/output device during a fourth threshold time not being identified, transmitting a control signal making the sound input/output device collect a noise signal during a fifth threshold time which is after the fourth threshold time to the sound input/output device.

In the step of identifying whether the sound signal includes a scene noise signal or an event noise signal (operation S1220), based on receiving a sound signal from the sound input/output device, the electronic apparatus may be powered on, and it may be identified whether the sound signal includes a scene noise signal or an event noise signal.

Methods according to the aforementioned various embodiments of the disclosure may be implemented in forms of applications that can be installed on conventional electronic apparatuses.

Also, the methods according to the aforementioned various embodiments of the disclosure may be implemented just by software upgrade, or hardware upgrade of conventional electronic apparatuses.

Further, it is possible that the aforementioned various embodiments of the disclosure are performed through an embedded server provided on the electronic apparatus or at least one external server.

The aforementioned various embodiments of the disclosure may be implemented in a recording medium that can be read by a computer or an apparatus similar to a computer, by using software, hardware, or a combination thereof. In some cases, the embodiments described in this specification may be implemented as the processor 120 itself. According to implementation by software, the embodiments such as procedures and functions described in this specification may be implemented as separate software modules. Each of the software modules may perform one or more functions and operations described in this specification.

Computer instructions for performing processing operations of the electronic apparatus 100 according to the aforementioned various embodiments of the disclosure may be stored in a non-transitory computer-readable medium. Computer instructions stored in such a non-transitory computer-readable medium make the processing operations at the electronic apparatus 100 according to the aforementioned various embodiments performed by a specific machine, when the instructions are executed by the processor of the specific machine.

Anon-transitory computer-readable medium refers to a medium that stores data semi-permanently, and is readable by machines. As specific examples of a non-transitory computer-readable medium, there may be a CD, a DVD, a hard disc, a blue-ray disc, a USB, a memory card, a ROM, and the like.

While example embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic apparatus comprising:
a communication interface; and
a processor configured to:
control the communication interface to output an audio content signal to a sound input/output device including a speaker and a microphone,
based on receiving a sound signal collected via the microphone from the sound input/output device via the communication interface, identify whether the sound signal includes a scene noise signal corresponding to a regular noise generated in a location in which the sound input/output device is located or an event noise signal corresponding to an irregular noise generated in the location in which the sound input/output device is located,
based on identifying that the sound signal includes the scene noise signal, perform noise cancelling for the sound signal, and
based on identifying that the sound signal includes the event noise signal, control the output of the audio content signal.

2. The electronic apparatus of claim 1, wherein the processor is further configured to, based on the sound signal received from the sound input/output device being a signal not including a user voice input, identify whether the sound signal includes the scene noise signal or the event noise signal.

3. The electronic apparatus of claim 1, wherein the processor is further configured to:
based on the sound signal received from the sound input/output device being a signal including a user voice input, identify whether the sound signal includes a wake-up word, and
based on the sound signal including the wake-up word, perform a voice recognition assistant function.

4. The electronic apparatus of claim 1, wherein the processor is further configured to, based on the sound signal including the event noise signal, perform an operation related to at least one of stopping of the output of the audio content signal, adjusting of an output volume of the audio content signal, or providing of a feedback corresponding to the event noise signal.

5. The electronic apparatus of claim 1, wherein the processor is further configured to:
input the sound signal into a first neural network model, and
identify whether the sound signal includes the scene noise signal or the event noise signal based on an output of the first neural network model, and
wherein the first neural network model is trained to, based on the sound signal being input, output information indicating whether the input sound signal is the scene noise signal or the event noise signal.

6. The electronic apparatus of claim 1, wherein the processor is further configured to, based on identifying that a first type of a first scene noise signal received from the sound input/output device during a first time frame is different from a second type of a second scene noise signal received from the sound input/output device during a second time frame which is before the first time frame, transmit, to the sound input/output device via the communication interface, a control signal that causes the sound input/output device to collect a noise signal during a third time frame which is after the first time frame.

7. The electronic apparatus of claim 1, wherein the processor is further configured to, based on a first type of a first scene noise signal received from the sound input/output device during a fourth time frame not being identified, transmit, to the sound input/output device via the communication interface, a control signal that causes the sound input/output device to collect a noise signal during a fifth time frame which is after the fourth time frame.

8. The electronic apparatus of claim 1, wherein the processor comprises:
an application processor; and
a main processor configured to, based on receiving the sound signal from the sound input/output device, control the application processor to be powered on, and
wherein the application processor is configured to identify whether the sound signal includes the scene noise signal or the event noise signal.

9. A system comprising:
an electronic apparatus;
a sound input/output device configured to:
output, via a speaker, an audio content signal received from the electronic apparatus,
identify whether a sound signal collected via a microphone includes a user voice input, and
transmit the sound signal and an identification result of whether the sound signal includes the user voice input to the electronic apparatus; and
wherein the electronic apparatus is configured to:
receive the sound signal collected via the microphone and the identification result,
based on identifying that the sound signal does not include the user voice input based on the identification result, identify whether the sound signal includes a scene noise signal corresponding to a regular noise generated in a location in which the sound input/output device is located or an event noise signal corresponding to an irregular noise generated in the location in which the sound input/output device is located,
based on the sound signal including the scene noise signal, perform noise cancelling for the sound signal, and
based on the sound signal including the event noise signal, control an output of the audio content signal.

10. The system of claim 9, wherein the sound input/output device includes a plurality of microphones that are provided in locations distanced from one another, and
wherein the sound input/output device is further configured to identify whether the sound signal collected via the microphone includes the user voice input based on strength differences of sound signals received via the plurality of microphones.

11. The system of claim 10, wherein the sound input/output device is further configured to:
input information related to whether the sound signal is a signal related to the user voice input and the sound signals collected via the plurality of microphones into a second neural network model; and
identify whether the sound signal includes the user voice input based on an output of the second neural network model.

12. A control method of an electronic apparatus, the control method comprising:
outputting an audio content signal to a sound input/output device including a speaker and a microphone;
based on receiving a sound signal collected via the microphone from the sound input/output device, identifying whether the sound signal includes a scene noise signal corresponding to a regular noise generated in a location in which the sound input/output device is located or an event noise signal corresponding to an irregular noise generated in the location in which the sound input/output device is located;
based on identifying that the sound signal includes the scene noise signal, performing noise cancelling for the sound signal; and
based on identifying that the sound signal includes the event noise signal, controlling the output of the audio content signal.

13. The control method of claim 12, wherein the identifying whether the sound signal includes the scene noise signal or the event noise signal comprises:
based on the sound signal received from the sound input/output device being a signal not including a user voice input, identifying whether the sound signal includes the scene noise signal or the event noise signal.

14. The control method of claim 12, further comprising:
based on the sound signal received from the sound input/output device being a signal including a user voice input, identifying whether the sound signal includes a wake-up word; and
based on the sound signal including the wake-up word, performing a voice recognition assistant function.

15. The control method of claim 12, further comprising:
based on the sound signal including the event noise signal, performing an operation related to at least one of stopping of the output of the audio content signal, adjusting of an output volume of the audio content signal, or providing of a feedback corresponding to the event noise signal.
